(19) United States
(12) Patent Application Publication
(10) Pub. No.: US 2015/0042796 A1
(43) Pub. Date: Feb. 12, 2015

(54) ANTI-DAMAGE ALARM SYSTEM FOR MACHINE

(71) Applicant: HON HAI PRECISION INDUSTRY CO., LTD., New Taipei (TW)

(72) Inventor: CHIA-HSIANG LU, New Taipei (TW)

(21) Appl. No.: 14/455,306

(22) Filed: Aug. 8, 2014

(30) Foreign Application Priority Data
Aug. 12, 2013 (CN) 201310348268X

(51) Int. Cl. G08B 21/18; G07F 9/02; H04N 7/18

(52) U.S. Cl. CPC G08B 21/182; H04N 7/188; G07F 9/026
USPC 348/143; 340/679

(57) ABSTRACT

An anti-damage alarm system for a vending machine includes an accelerometer, a processing unit, and an alarm device. The accelerometer measures accelerations of the vending machine. The processing unit calculates vibration angles of the vending machine according to the measured accelerations of the vending machine, and determines whether an alarm condition is met according to the vibration angles of the vending machine. When the alarm condition is met, the alarm device emits an alarm. An anti-damage alarm method is also disclosed.

### CROSS-REFERENCE TO RELATED APPLICATIONS

This application claims priority to China Patent Application No. 201310348268.X filed on Aug. 12, 2013 in the State Intellectual Property Office of China, the contents of which are hereby incorporated by reference.

### FIELD

The disclosure generally relates to alarm systems, and more particularly relates to anti-damage alarm systems for a machine.

### BACKGROUND

Vending machines have been in common use for vending a variety of items such as snacks, beverages, alcohol, cigarettes, lottery tickets, cologne, consumer products, and even gold and gems. However, the vending machines are often placed in an unattended place, which may bring a risk of damage to the vending machines caused by unauthorized persons.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the views.

FIG. 1 is a block diagram of an embodiment of an anti-damage alarm system for a vending machine.

FIG. 2 is a flowchart of an embodiment of an anti-damage alarm method for a vending machine.

### DETAILED DESCRIPTION

The disclosure is illustrated by way of example and not by way of limitation in the figures of the accompanying drawings, in which like reference numerals indicate similar elements. It should be noted that references to “an” or “one” embodiment in this disclosure are not necessarily to the same embodiment, and such references can mean “at least one.”

In general, the word “module,” as used herein, refers to logic embodied in hardware or firmware, or to a collection of software instructions, written in a programming language such as Java, C, or assembly. One or more software instructions in the modules may be embedded in firmware, such as in an erasable-programmable read-only memory (EPROM). The modules described herein may be implemented as either software and/or hardware modules and may be stored in any type of non-transitory computer-readable medium or other storage device. Some non-limiting examples of non-transitory computer-readable media are compact discs (CDs), digital versatile discs (DVDs), Blu-Ray discs, Flash memory, and hard disk drives.

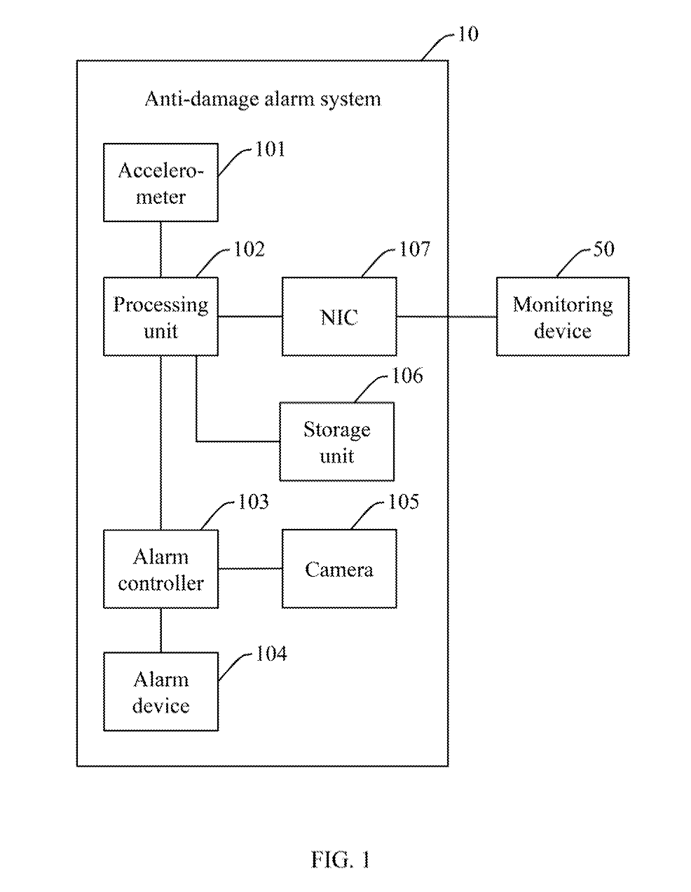

FIG. 1 illustrates an embodiment of an anti-damage alarm system 10 for a vending machine. The anti-damage alarm system 10 can include an accelerometer 101, a processing unit 102, an alarm controller 103, an alarm device 104, a camera 105, a storage unit 106, and a network interface controller (NIC) 107.

The accelerometer 101 can be installed in a vending machine and measure accelerations of the vending machine. The accelerometer 101 can transmit the accelerations of the vending machine to the processing unit 102.

The processing unit 102 can be implemented or performed with a general purpose processor, a content addressable memory, a digital signal processor, an application specific integrated circuit, a field programmable gate array, any suitable programmable logic device, discrete gate or transistor logic, discrete hardware components, or any combination designed to perform the functions described herein.

The processing unit 102 can calculate vibration angles of the vending machine according to the measured accelerations of the vending machine. The processing unit 102 can determine whether an alarm condition is met according to the vibration angles of the vending machine. When one of the vibration angles of the vending machine exceeds a predetermined angle, the processing unit 102 can determine that the vending machine is being damaged and the alarm condition is met.

The processing unit 102 can further calculate changes between vibration angles of the vending machine. The processing unit 102 can determine an alarm mode according to the changes between the vibration angles. For example, when the changes between vibration angles do not exceed a predefined threshold value, the processing unit 102 can set the alarm mode to a first mode. When at least one change between vibration angles of the vending machine exceeds the predefined threshold value, the processing unit 102 can set the alarm mode to a second mode.

The alarm controller 103 is coupled to the processing unit 102. When the processing unit 102 determines that the alarm condition is met, the processing unit 102 can transmit a control signal corresponding to the alarm mode to the alarm controller 103.

The alarm device 104 and the camera 105 are coupled to the alarm controller 103. The alarm device 104 can be a visual alarm device, such as a strobe light, which can flash light, or an audible alarm device, such as a loudspeaker, which can produce sound. The camera 105 can record images of surroundings of the vending machine. The images can be photographs, or moving images such as videos. In some embodiments, the camera 105 can record videos with sound.

The storage unit 106 is coupled to the processing unit 102, such that the processing unit 102 can read information from, and write information to, the storage unit 106. The storage unit 106 can be realized as RAM memory, flash memory, EPROM memory, EEPROM memory, registers, a hard disk, a removable disk, a CD-ROM, or any other form of storage medium known in the art.

The NIC 107, also known as a network adapter, can enable the anti-damage alarm system 10 to communicate over an Internet Protocol (IP) network, such as a local area network (LAN) or the Internet.

In at least one embodiment, the anti-damage alarm system 10 communicates with a remotely located monitoring device 50 via an IP network. When the processing unit 102 determines that the alarm condition is met, the processing unit 102 can transmit an alarm message corresponding to the alarm mode to the monitoring device 50, and simultaneously transmit the corresponding control signal to the alarm controller 103. When the monitoring device 50 receives the alarm message, the monitoring device 50 can provide a visible or audible interface to inform a user of the monitoring device 50. The monitoring device 50 can be, but is not limited to, a personal computer, a server computer, a tablet computer, a personal digital assistant (PDA), a smart phone, or any other type of portable or non-portable electronic device.

When the alarm controller 103 receives the control signal corresponding to the first mode, the alarm controller 103 can control the alarm device 104 to emit an alarm to draw attention to proximate persons around the vending machine.

When the alarm controller 103 receives the control signal corresponding to the second mode, in addition to controlling the alarm device 104 to emit an alarm, the alarm controller 103 controls the camera 105 to record images of the surroundings of the vending machine. The recorded images can be stored in the storage unit 106. The processing unit 102 can retrieve the recorded images from the storage unit 106 and transmit the recorded images to the monitoring device 50 via the IP network.

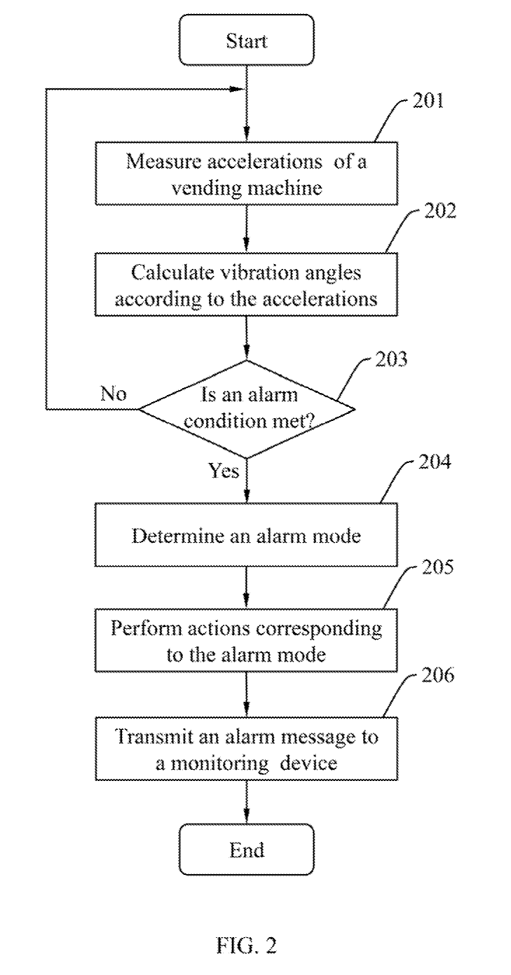

FIG. 2 illustrates a flowchart of one embodiment of an anti-damage alarm method for a vending machine. The method includes the following steps.

In block 201, an accelerometer measures accelerations of a vending machine, and transmits the accelerations of the vending machine to a processing unit.

In block 202, the processing unit calculates vibration angles of the vending machine according to the measured accelerations of the vending machine.

In block 203, the processing unit determines whether an alarm condition is met according to the vibration angles of the vending machine. If one of the vibration angles of the vending machine exceeds a predetermined angle, the processing unit determines that the alarm condition is met, and block 204 is implemented. Otherwise, if the alarm condition is not met, block 201 is implemented.

In block 204, the processing unit calculates changes between the vibration angles of the vending machine, and determines an alarm mode according to the changes between the vibration angles of the vending machine. For example, when the changes between the vibration angles of the vending machine do not exceed a predefined threshold value, the processing unit sets the alarm mode to a first mode (mode I). When one of the changes between the vibration angles of the vending machine exceeds a predefined threshold value, the processing unit sets the alarm mode to a second mode (mode II). The processing unit transmits a control signal corresponding to the alarm mode to an alarm controller.

In block 205, the alarm controller performs actions corresponding to the alarm mode. When the alarm controller receives the control signal corresponding to the first mode, the alarm controller controls an alarm device to emit an alarm to draw attention to proximate persons around the vending machine. When the alarm controller receives the control signal corresponding to the second mode, the alarm controller controls an alarm device to emit an alarm, and simultaneously controls a camera to record images of the surroundings of the vending machine. The recorded images can be stored in a storage unit.

In block 206, the processing unit transmits an alarm message corresponding to the alarm mode to a monitoring device via an IP network. In response to the alarm message, the monitoring device provides a visible or audible interface to inform a user of the monitoring device. When the alarm mode is the second mode, the processing unit is further configured to retrieve the recorded images from the storage unit, and transmit the recorded images to the monitoring device.

In particular, depending on the embodiment, certain steps or methods described may be removed, others may be added, and the sequence of steps may be altered. The description and the claims drawn for or in relation to a method may give some indication in reference to certain steps. However, any indication given is only to be viewed for identification purposes, and is not necessarily a suggestion as to an order for the steps.

Although numerous characteristics and advantages have been set forth in the foregoing description of embodiments, together with details of the structures and functions of the embodiments, the disclosure is illustrative only, and changes may be made in detail, including in the matters of arrangement of parts within the principles of the disclosure. The disclosed embodiments are illustrative only, and are not intended to limit the scope of the following claims.

What is claimed is:

1. An anti-damage alarm system for a machine, comprising:
an accelerometer configured to measure accelerations of the machine;
a processing unit configured to calculate vibration angles of the machine according to the measured accelerations of the machine and determine whether an alarm condition is met according to the vibration angles of the machine; and
an alarm device configured to emit an alarm when the processing unit determines that the alarm condition is met.

2. The anti-damage alarm system of claim 1, wherein the machine is a vending machine.

3. The anti-damage alarm system of claim 1, wherein the processing unit is further configured to transmit an alarm message to a remotely located monitoring device via a network when the processing unit determines that the alarm condition is met.

4. The anti-damage alarm system of claim 1, wherein when one of the vibration angles of the machine exceed a predetermined angle, the processing unit is configured to determine that the alarm condition is met.

5. The anti-damage alarm system of claim 1, further comprising a camera configured to record images of surroundings of the machine when the processing unit determines that the alarm condition is met.

6. The anti-damage alarm system of claim 5, wherein the processing unit is further configured to transmit the recorded images to a remotely located monitoring device via a network.

7. An anti-damage alarm system for a vending machine, comprising:
an accelerometer configured to measure accelerations of the vending machine;
a processing unit coupled to the accelerometer, wherein the processing unit is configured to calculate vibration angles of the vending machine according to the measured accelerations of the vending machine and determine whether an alarm condition is met according to the vibration angles of the vending machine; when the processing unit determines that the alarm condition is met, the processing unit is further configured to calculate changes between the vibration angles of the vending machine and determine an alarm mode according to the changes between the vibration angles of the vending machine; and
an alarm controller coupled to the processing unit configured to perform actions corresponding to the alarm mode.

8. The anti-damage alarm system of claim 7, wherein the processing unit is further configured to transmit an alarm message with the alarm mode to a remotely located monitoring device via a network. Page 11 of 15

9. The anti-damage alarm system of claim 7, wherein when the vibration angles of the vending machine exceed a predetermined angle, the processing unit is configured to determine that the alarm condition is met.

10. The anti-damage alarm system of claim 7, wherein when the changes between the vibration angles do not exceed a predefined threshold value, the processing unit is configured to set the alarm mode to a first mode; when one of the changes between the vibration angles exceeds the predefined threshold value, the processing unit is configured to set the alarm mode to a second mode.

11. The anti-damage alarm system of claim 10, further comprising an alarm device, wherein when the alarm mode is set to the first mode, the alarm controller is configured to control the alarm device to emit an alarm.

12. The anti-damage alarm system of claim 10, further comprising an alarm device and a camera, wherein when the alarm mode is set to the second mode, the alarm controller is configured to control the alarm device to emit an alarm and control the camera to record images of surroundings of the vending machine.

13. The anti-damage alarm system of claim 12, wherein the processing unit is further configured to transmit the recorded images to a remotely located monitoring device via a network.

14. An anti-damage alarm method for a vending machine, comprising:
measuring accelerations of the vending machine by an accelerometer;
calculating vibration angles of the vending machine according to the measured accelerations of the vending machine;
determining whether an alarm condition is met according to the vibration angles of the vending machine; and
controlling an alarm device to emit an alarm when it is determined that the alarm condition is met.

15. The anti-damage alarm method of claim 14, further comprising:
transmitting an alarm message to a remotely located monitoring device via a network when the processing unit determines that the alarm condition is met.

16. The anti-damage alarm method of claim 14, determining whether an alarm condition is met comprising:
determining that the alarm condition is met when one of the vibration angles of the vending machine exceeds a predetermined angle.

17. The anti-damage alarm method of claim 14, further comprising:
recording images of surroundings of the vending machine when it is determined that the alarm condition is met.

18. The anti-damage alarm method of claim 17, further comprising:
transmitting the recorded images to a remotely located monitoring device via a network.
